(19) United States
(12) Patent Application Publication
(10) Pub. No.: US 2015/0310036 A1
(43) Pub. Date: Oct. 29, 2015

(54) MAPPING A LOCATION TO AN AREA

(71) Applicants: Lauri WIROLA, Tampere (FI); Tommi Antero LAINE, Tampere (FI)

(72) Inventors: Lauri WIROLA, Tampere (FI); Tommi Antero LAINE, Tampere (FI)

(73) Assignee: Nokia Corporation, Espoo (FI)

(21) Appl. No.: 14/417,242

(22) PCT Filed: Aug. 10, 2012
(86) PCT No.: PCT/IB2012/054083

§ 371 Date: Apr. 28, 2015

(51) Int. Cl. G06F 17/30

(52) U.S. Cl. CPC G06F 17/30241; G06F 17/30327

(57) ABSTRACT

An apparatus receives coordinates of a location and selects an object of a first layer of a tree structure based on the coordinates. The apparatus determines whether data assigned to the selected object comprises an identifier of an area or a pointer to a set of objects of a respective next layer of the tree structure. If the data comprises a pointer to a set of objects, the apparatus selects one of the objects from the set of objects based on the received coordinates and continues with determining whether data assigned to the selected object comprises an identifier or a pointer. If the data comprises an identifier of an area, the apparatus reads the data comprising the identifier and provides the identifier as a result of a mapping of a location to an identifier of an area. A computer readable storage medium stores a database having a corresponding tree structure.

### FIELD OF THE DISCLOSURE

The invention relates to the mapping of a location to an area, and more specifically to the mapping of a location to an identifier of an area.

### BACKGROUND

Modern global cellular and non-cellular positioning technologies are based on generating large global databases containing information on cellular and non-cellular signals. The information may originate entirely or partially from users of these positioning technologies. This approach is also referred to as “crowd-sourcing”.

The information provided by users is typically in the form of “fingerprints”, which contain a location that is estimated based on, e.g., received satellite signals of a global navigation satellite system (GNSS) and measurements taken from one or more radio interfaces for signals of a cellular and/or non-cellular terrestrial system. In the case of measurements on cellular signals, the results of the measurements may contain a global and/or local identification of the cellular network cells observed, their signal strengths and/or pathlosses and/or timing measurements like timing advance (TA) or round-trip time. For measurements on wireless local area network (WLAN) signals, as an example of signals of a non-cellular system, the results of the measurements may contain a basic service set identification (BSSID), like the medium access control (MAC) address of observed access points (APs), the service set identifier (SSID) of the access points, and the signal strength of received signals (received signal strength indication RSSI or physical Rx level in dBm with a reference value of 1 mW, etc.).

This data may then be transferred to a server or cloud, where the data may be collected and where further models may be generated based on the data for positioning purposes. Such further models can be coverage area estimates, node positions and/or radio channel models, with base stations of cellular communication networks and access points of WLANs being exemplary nodes. In the end, these refined models may be used for estimating the position of mobile terminals.

Fingerprints do not necessarily have to comprise a GNSS based position. They could also include cellular and/or WLAN measurements only. In this case the fingerprint could be assigned a position for example based on a WLAN based positioning in a server. Such self-positioned fingerprints can be used to learn cellular network information, in case there are cellular measurements in the fingerprint. Moreover, in the set of WLAN measurements in the fingerprint there may be, in addition to measurements for known WLAN access points, also measurements for unknown access points, and the position of the unknown access points can be learned through these self-positioned fingerprints. Finally, more data can be learned for previously known access points based on self-positioned fingerprints.

It may be noted that even when using a mobile terminal having GNSS-capabilities, a user may benefit from using cellular/non-cellular positioning technologies in terms of time-to-first-fix and power consumption. Also, not all applications require a GNSS-based position. Furthermore, cellular/non-cellular positioning technologies work indoors as well, which is generally a challenging environment for GNSS-based technologies.

### SUMMARY OF SOME EMBODIMENTS OF THE INVENTION

For a first aspect, a method is described which comprises at an apparatus:
a) receiving coordinates of a location;
b) selecting an object of a first layer of a tree structure based on the received coordinates;
c) determining whether data assigned to the selected object comprises an identifier of an area or a pointer to a set of objects of a respective next layer of the tree structure, wherein each object represents a region and wherein a region represented by an object of any layer but the first layer is a sub-region of a region represented by an object of a preceding layer;
d) if the data comprises a pointer to a set of objects, selecting one of the objects from the set of objects based on the received coordinates and continuing with action c); and
e) otherwise, if the data comprises an identifier of an area, reading the data comprising the identifier and providing the identifier as a result of a mapping of a location to an identifier of an area.

For the first aspect, moreover a first apparatus is described which comprises means for realizing the actions of the method presented for the first aspect.

The means of this apparatus can be implemented in hardware and/or software. They may comprise for instance a processor for executing computer program code for realizing the required functions, a memory storing the program code, or both. Alternatively, they could comprise for instance circuitry that is designed to realize the required functions, for instance implemented in a chipset or a chip, like an integrated circuit.

For the first aspect, moreover a second apparatus is described, which comprises at least one processor and at least one memory including computer program code, the at least one memory and the computer program code configured to, with the at least one processor, cause an apparatus at least to perform the actions of the method presented for the first aspect.

For the first aspect, moreover a non-transitory computer readable storage medium is described, in which computer program code is stored. The computer program code causes an apparatus to perform the actions of the method presented for the first aspect when executed by a processor.

For a second aspect, a non-transitory computer readable storage medium is described, in which a database is stored. The database is configured to have a tree structure which enables storage of objects arranged in at least two layers, wherein each object represents a region and wherein a region represented by an object of any layer but the first is a sub-region of a region represented by an object of the preceding layer, with objects of at least one of the layers being at least configured to comprise a pointer to a set of objects of a next layer, and with objects of at least one of the layers being at least configured to comprise a respective identifier of an area.

For both aspects, the computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood for the first aspect that also the computer program code by itself has to be considered an embodiment of the invention, and for the second aspect that also the database by itself has to be considered an embodiment of the invention.

For the second aspect, moreover an apparatus is described, which comprises the non-transitory computer readable storage medium presented for the second aspect.

Moreover a system is described, which comprises any apparatus as presented for the first aspect and a computer readable storage medium as presented for the second aspect. If the comprised apparatus is a mobile device, the system could optionally comprise in addition at least one server. If the comprised apparatus is a server, the system could optionally comprise in addition at least one mobile device and/or at least one server.

Any of the described apparatuses may comprise only the indicated components or one or more additional components.

Any of the described apparatuses may be a module or a component for a device, for example a chip. Alternatively, any of the described apparatuses may be a device, for instance a server or a mobile terminal.

In one embodiment, the described method for the first aspect is an information providing method, and the described apparatuses are information providing apparatuses. In one embodiment, the means of the described first apparatus for the first aspect are processing means.

In certain embodiments of the described method, the method is a method for mapping a location to an identifier of an area. In certain embodiments of the described apparatuses, the apparatuses are apparatuses for mapping a location to an identifier of an area.

It is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an exemplary embodiment of an apparatus according to the first aspect;

FIG. 2 is a flow chart illustrating an exemplary embodiment of a method according to the first aspect;

FIG. 3 is a schematic block diagram of an exemplary embodiment of a computer readable medium according to the second aspect;

FIG. 4 is a schematic block diagram of an exemplary system;

FIG. 5 is a diagram illustrating the structure of an exemplary database;

FIG. 6 is a flow chart illustrating an exemplary first operation in the system of FIG. 4; and

FIG. 7 is a diagram illustrating an exemplary creation of database content.

### DETAILED DESCRIPTION OF THE FIGURES

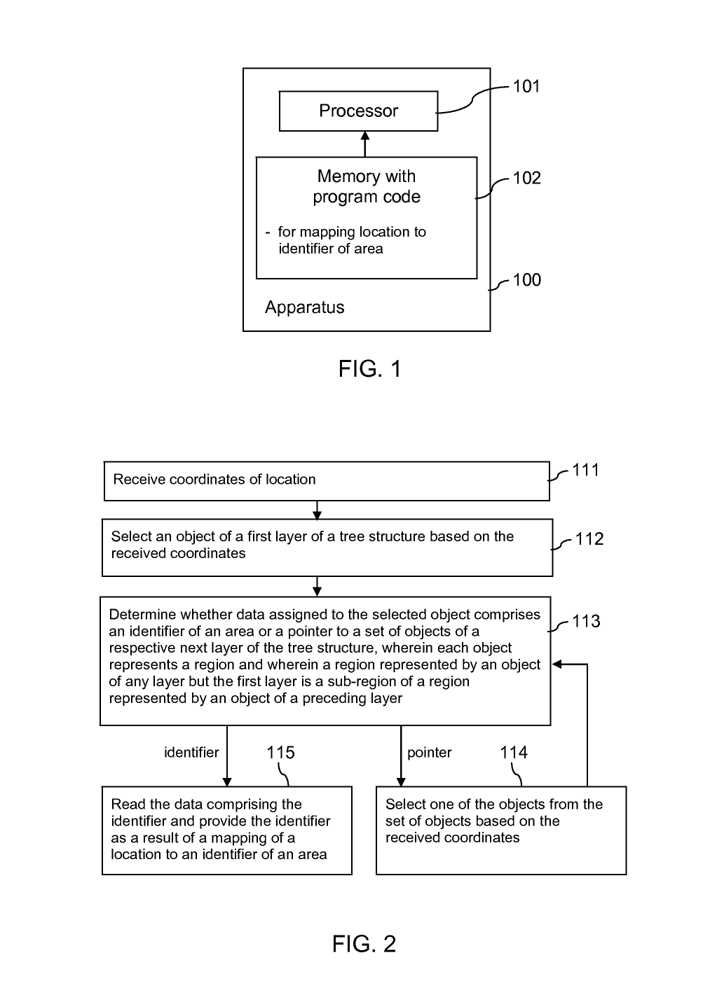

FIG. 1 is a schematic block diagram of an exemplary apparatus 100. Apparatus 100 comprises a processor 101 and, linked to processor 101, a memory 102. Memory 102 stores computer program code for mapping a location to an identifier of an area. Processor 101 is configured to execute computer program code stored in memory 102 in order to cause an apparatus to perform desired actions.

Apparatus 100 could be a server or any other device, for instance a mobile device. Such a mobile device could be for example a communication terminal, like a mobile phone, a smart phone, a laptop, a tablet computer, etc. Apparatus 100 could equally be a module, like a chip, circuitry on a chip or a plug-in board, for a server or for any other device. Apparatus 100 is an exemplary embodiment of any apparatus according to the presented first aspect. Optionally, apparatus 100 could comprise various other components, like a data interface, a user interface, a further memory, a further processor, etc.

An operation of apparatus 100 will now be described with reference to the flow chart of FIG. 2. The operation is an exemplary embodiment of a method according to the presented first aspect. Processor 101 and the program code stored in memory 102 cause an apparatus to perform the operation when the program code is retrieved from memory 102 and executed by processor 101. The apparatus that is caused to perform the operation can be apparatus 100 or some other apparatus, in particular a device comprising apparatus 100.

The apparatus receives coordinates of a location. (action 111) The coordinates could comprise for instance a longitude value and a latitude value. Such longitude and latitude values can be based on different geodetic systems, WGS 84 being one example only.

The apparatus furthermore selects an object of a first layer of a tree structure based on the received coordinates. (action 112)

The apparatus furthermore determines whether data assigned to the selected object comprises an identifier of an area or a pointer to a set of objects of a respective next layer of the tree structure. Each object represents a region, and a region represented by an object of any layer but the first layer is a sub-region of a region represented by an object of a preceding layer. (action 113)

If the data comprises a pointer to a set of objects, the apparatus furthermore selects one of the objects from the set of objects based on the received coordinates. (action 114) The apparatus then continues with action 113.

Otherwise, if the data comprises an identifier of an area, the apparatus reads the data comprising the identifier and provides the identifier as a result of a mapping of a location to an identifier of an area. (action 115)

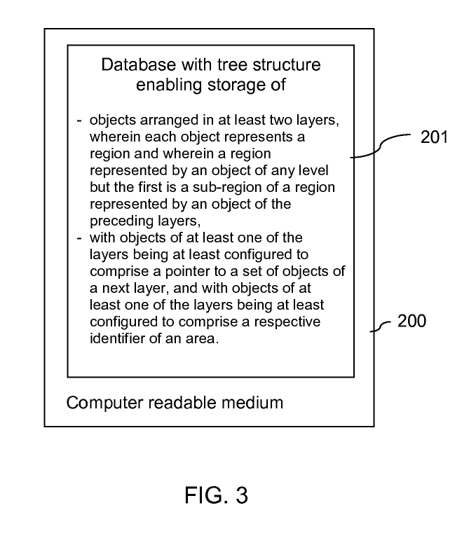

FIG. 3 is a schematic block diagram of an exemplary embodiment of a non-transitory computer readable medium 200 according to the second aspect.

In computer readable storage medium 200, a database 201 is stored. The database 201 is configured to have a tree structure which enables storage of objects arranged in at least two layers. Each object represents a region, and a region represented by an object of any layer but the first is a sub-region of a region represented by an object of the preceding layers. Objects of at least one of the layers are at least configured to comprise a respective identifier of an area, and objects of at least one of the layers are at least configured to comprise a pointer to a set of objects of a next layer.

It is to be understood that optionally, the objects of at least one of the layers may be configured to store either a pointer to another layer or an identifier of an area. It is further to be understood that optionally, the objects of at least one of the layers may be configured to store either a pointer to another layer or an identifier of an area or some other information. It is further to be understood that optionally, the objects of at least one of the layers may be configured to store either an identifier of an area or some other information. It is further to be understood that optionally, the objects of at least one of the layers may be configured to store either a pointer to another layer or some other information.

In an exemplary embodiment, computer readable storage medium 200 could thus provide a database with the tree structure that is used in the operation of FIG. 2.

Computer readable storage medium 200 could be a part of an apparatus with processing capabilities, for instance of a server or any other device, for instance a mobile device. The server could be for instance a file server or a positioning server providing more comprehensive functions. The mobile device could be for example a communication terminal, like a mobile phone, a smart phone, a laptop, a tablet computer, etc. Alternatively, computer readable storage medium 200 could be or belong to a passive apparatus that can be accessed by a device with processing capabilities.

In some scenarios it may be advantageous to be able to map coordinates of a location to an area, and more specifically to an identifier of an area. It may be desired, for example, to split a global WLAN database into multiple databases based on countries, using a separate database for different sets of countries. If WLAN fingerprint data for updating such databases comprises location information but no indication of the country in which the data was collected, the location information first needs to be mapped to an identifier of the correct country so that the fingerprint data or processed fingerprint data can be stored into the correct database. A similar need of mapping a location to an area may arise for other types of data and for other use cases.

Certain embodiments of the presented first aspect therefore provide that an apparatus may use a multi-layered geospatial tree for mapping available coordinates of a location to an identifier of an area, in which the location is located.

Certain embodiments of the presented second aspect provide in a complementary manner that a storage medium stores a database which provides a multi-layered geospatial tree structure, in which at least some objects may be configured to store an identifier of an area.

Each of the first and second aspect may thus enable a quick access to data that is suitable for a mapping of a location to an identifier of an area. In addition, each of the first and second aspect may enable a storage of mapping data in a manner that requires little storage space. The entire data could fit into a random access memory (RAM), which may further reduce the time that is required to obtain the required data when needed.

In this text, receiving of coordinates by an apparatus may refer, for example, to receiving the coordinates from another apparatus of another device, to receiving the coordinates from another apparatus in the same device, to receiving the coordinates from another component of the same apparatus and/or to receiving the coordinates within the apparatus by the execution of a piece of program code, etc.

Apparatus 100 illustrated in FIG. 1 and the method illustrated in FIG. 2 may be implemented and refined in various ways. Computer readable storage medium 200 illustrated in FIG. 3 may equally be implemented and refined in various ways. Computer readable storage medium 200 could also be combined in exemplary embodiments with functions of apparatus 100 in a single device. In this case, computer readable storage medium 200 could be identical to memory 102 and store both, program code and database, or it could be provided in addition to memory 102.

In an exemplary embodiment of both presented aspects, the identifier of an area may comprise a mobile country code. This may have the effect that an existing definition may be reused.

Mobile country codes (MCC) are defined in ITU E.212 (“Land Mobile Numbering Plan”). A mobile country code is used together with a mobile network code (MNC) for uniquely identifying a mobile communication network. It comprises three digits. To most countries, a single code is assigned. The code ‘244’ is assigned for instance to Finland. To a few countries, several codes are assigned. The codes ‘404’, ‘405’ and ‘406’ are assigned for instance to India. The mobile country code can be included in signals transmitted by nodes of a cellular communication network. In a global system for mobile communications (GSM), in a wide-band code division multiple access (WCDMA) system, in a time division synchronous CDMA (TD-SCDMA) system and in a long term evolution (LTE) system, for instance, the MCC/MNC pair forms the public land mobile network (PLMN) identification as a part of the global cell identification (GO).

It is to be understood that for both aspects presented here, special codes may be defined in addition. As such special codes, codes that are reserved in ITU E.212 for other purposes could be used, for example, since these codes may not be needed for the presented aspects. At least one special code could be defined for instance for regions that do not belong to any country.

Moreover, it is to be understood that alternatively to using MCCs, a different set of identifiers could be defined as well. Dedicated identifiers could be defined for different areas and, if desired, special identifiers could be defined in addition, for instance at least one special identifier for all regions that do not belong to any area, for which a dedicated identifier has been defined.

In an exemplary embodiment of both presented aspects, the tree structure comprises three layers. Each object of the first layer represents a region of one degree in longitude direction and one degree in latitude direction, each object of the second layer represents a region of 0.1 degree in longitude direction and 0.1 degree in latitude direction, and each object of the third layer represents a region of 0.01 degree in longitude direction and 0.01 degree in latitude direction. Such a structure may have the effect that available coordinates may be easily converted into indices of the objects enabling an access to the objects, in case such indices of the objects are defined based on the regions they represent.

In an exemplary embodiment of the first presented aspect, an object is selected based on the received coordinates by computing an index for the object based on the received coordinates.

In an exemplary implementation of this embodiment, an index of an object of a first layer is computed as a combination of an integer part of a latitude coordinate value in degrees of the received coordinates and of an integer part of a longitude coordinate value in degrees of the received coordinates. An index of an object of a second layer is computed as a combination of a first place after a decimal point of a latitude coordinate value in degrees of the received coordinates and of a first place after a decimal point of a longitude coordinate value in degrees of the received coordinates. An index of an object of a third layer is computed as a combination of a second place after a decimal point of a latitude coordinate value in degrees of the received coordinates and of a second place after a decimal point of a longitude coordinate value in degrees of the received coordinates.

It is to be understood that indices of further layers of the tree structure could be computed in a corresponding manner, in case further layers are desired.

The index of an object could be for instance an index in an indexed sorted list of objects. Alternatively, it could be for instance the combination of a row number and of a column number of a table, in which the data of an object is included as a respective element of the table. The latter approach may have the advantage that the index of objects forming the elements of a table may not consume additional storage space.

In an exemplary embodiment of both presented aspects, an object may comprise an identifier of an area either in case the object is an object of a lowest layer of the tree structure or in case the object represents a region that belongs in its entirety to the area. This may have the effect that further storage space may be saved, since there may be no objects of a lower layer for many objects of a higher layer.

In an exemplary embodiment of both presented aspects, an object of a lowest layer of the tree structure may comprise an identifier of an area, which is selected such that the region represented by the object belongs entirely to the area, or such that the largest part of the region represented by the object belongs to the area. This may have the effect that a particular identifier may be assigned to all objects of the lowest layer, even if in real life, the region represented by an object of the lowest layer partly belongs to a first area and partly to a second area.

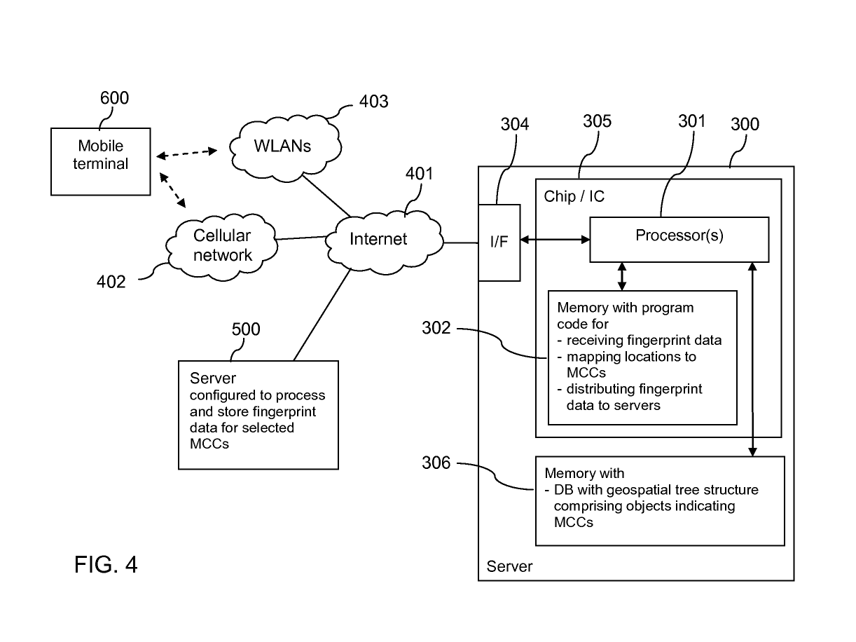

FIG. 4 is a schematic block diagram of an exemplary system, which supports a mapping of a location to an identifier of an area. The system and its operation may comprise embodiments of the first and second aspect.

The system comprises a server 300. Server 300 is connected to a network 401, for example the Internet or a local area network. Server 300 could also belong to network 401. Network 401 is suited to interconnect server 300 with other servers 500. Network 401 is further suited to interconnect server 300 with mobile terminals 600 via a cellular network 402 and/or via WLANs 403.

Server 300 may be for instance a positioning data distribution server, or some other kind of server. It comprises a processor 301 that is linked to a first memory 302, to a second memory 306 and to an interface (I/F) 304. Processor 301 is configured to execute computer program code, including computer program code stored in memory 302, in order to cause server 300 to perform desired actions.

Memory 302 stores computer program code for mapping locations to MCCs. The computer program code may comprise for example similar program code as memory 102. The computer program code may further comprise for instance code for receiving fingerprint data from mobile terminals and for distributing the fingerprint data to servers. In addition, memory 302 may store computer program code implemented to realize other functions, as well as any kind of other data. It is to be understood, though, that program code for any other actions than for mapping locations to MCCs could also be implemented on one or more other physical and/or virtual servers.

Processor 301 and memory 302 may optionally belong to a chip or an integrated circuit 305, which may comprise in addition various other components, for instance a further processor or memory.

Memory 306 stores a database that can be accessed by processor 301. The database is configured to store a geospatial tree structure comprising objects indicating MCCs. In addition, memory 306 could store other data. It is to be understood that a memory storing the database could also be external to server 300; it could be for instance on another physical or virtual server.

The database provides a tree structure with three layers of objects.

Each object of the first layer represents a region having a size of 1°×1°. With 180 degrees of latitude and 360 degrees of longitude of a virtual grid covering the surface of the Earth, there are thus 180*360=64800 objects in the first layer.

If the objects of the first layer are provided as a indexed sorted list of objects, an object of the first layer could be identified by an index of 2 bytes. By way of example it is assumed, however that the first layer is implemented as a static two-dimensional table. Thus, an object could correspond to an element of the table and be identified by its position in the table. The index is thus given implicitly by the combination of a column number and a row number of the table. In this case, each element of the table and thus each object may take up only 9 bytes. 1 byte may indicate the type of data that is assigned to the object. The type can be either “MCC” or “pointer”. 8 bytes may be provided for the data, and thus either for the actual MCC or for a pointer to the next layer. The 64800 objects of the first layer thus consume 0.6 Mbytes of the storage space.

Each object of the second layer represents a region having a size of 0.1°×0.1°. There could thus be 100 objects in the second layer for each object of the first layer.

However, 70% of the objects of the first layer could carry an MCC as data, and only 30% could carry a pointer to the second layer. In this case, there would be only 0.3*64,800*100=1,944,000 objects in the second layer. The objects of the second layer for a respective object of the first layer could be provided in the form of an indexed sorted list. The size of an object of the second layer could then be 10 bytes. 1 byte may be used for an index of the object. 1 byte may indicate the type of data that is assigned to the object. The type can be again either “MCC” or “pointer”. 8 bytes may be provided for the data, and thus either for the MCC or for a pointer to the next layer. So the second layer might consume 20 Mbytes of storage space.

Each object of the third layer represents a region having a size of 00.1°×00.1°. There may thus be 100 objects in the third layer for each object of the second layer.

Only some of the objects of the second layer might comprise a pointer to the third layer as data, while other objects could carry an MCC as data. However, for the sake of illustration it is assumed that each object of the second layer points to the third layer. With 100 objects of the third layer under each of the 1,944,000 objects of the second layer, there would be a total of 194,400,000 objects of the third layer. The objects of the third layer for a respective object of the second layer could be provided in the form of an indexed sorted list as well. The objects of the third layer may consume only 3 bytes. 1 byte can be used for an index, and another 2 bytes may be used for indicating an MCC. Therefore, the objects of the third layer may consume at maximum 560 Mbytes of storage space. The amount would be even lower when taking into account, as for the second layer, that some of the objects of the second layer might comprise an MCC instead of a pointer to the next layer.

In order to further reduce the required amount of storage space, a respective set of 100 objects of the second and third layers could be provided in the form of a static table too, with a number of a row and a number of a column implicitly providing the index for a respective element of the table and thus for a respective object.

In conclusion, the Location-to-MCC mapping table in the form of a geospatial tree consumes very little storage space of less than 600 Mbytes. As a result, it could be maintained in a RAM of server 300 all the time for quick access. Memory 306 could thus be a RAM or a memory from which data is loaded into a RAM when server 300 is put into operation.

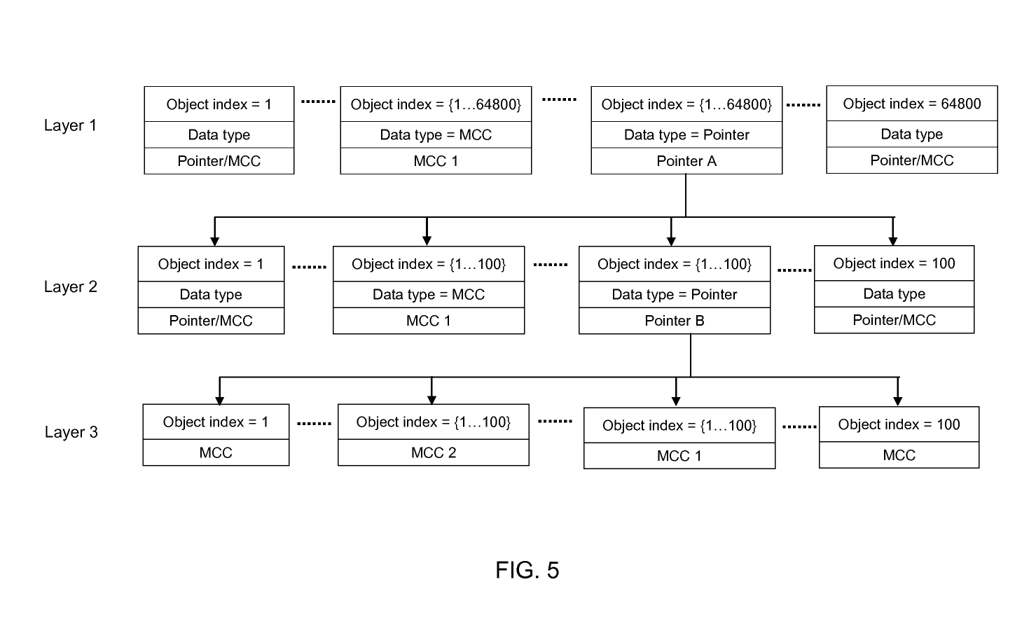

FIG. 5 illustrates an exemplary tree structure.

It shows objects with indices “1” to “64,800” of a first layer, Layer 1. The data type of each of these objects can be indicated within the object to be “MCC” or “pointer”, and accordingly, the object may comprise an MCC or a pointer. One of these Layer 1 objects is shown by way of example to comprise an MCC “1”. Another one of the Layer 1 objects is shown by way of example to comprise a pointer “A” to the second layer, Layer 2, and more specifically to a set of 100 Layer 2 objects.

FIG. 5 further shows this exemplary set of Layer 2 objects with indices “1” to “100”. A corresponding set of 100 Layer 2 objects is provided for each Layer 1 object that comprises a pointer to the second layer. The data type of each of these Layer 2 objects can be indicated within the object to be “MCC” or “pointer”, and accordingly, the object may comprise an MCC or a pointer. One of the depicted Layer 2 objects is shown by way of example to comprise an MCC “1”. Another of the depicted Layer 2 objects is shown by way of example to comprise a pointer “B” to the third layer, Layer 3, and more specifically to a set of 100 Layer 3 objects.

FIG. 5 further shows this exemplary set of Layer 3 objects with indices “1” to “100”. A corresponding set of 100 Layer 3 objects is provided for each Layer 2 object that comprises a pointer to the third layer. Each Layer 3 object comprises an MCC; thus an indication of a data type is not required. One of the depicted Layer 3 objects is shown by way of example to comprise an MCC “1”. Another of the depicted Layer 3 objects is shown by way of example to comprise an MCC “2”.

It is to be understood that indices “1” to “64,800” represent any kind of 64,800 different indices for Layer 1, and that indices “1” to “100” represent any kind of 100 different indices for Layer 2 and Layer 3. It is further to be understood that the notation MCC “1” and MCC “2” is used to represent any two of the three digit mobile country codes.

Interface 304 is a component which enables server 300 to communicate with other devices, like servers 500 and mobile terminals 600, via network 401. Interface 304 could comprise for instance a TCP/IP socket.

Component 305 or server 300 could correspond to exemplary embodiments of an apparatus according to the presented first aspect, memory 306 could correspond to an exemplary embodiment of a computer readable medium according to the presented second aspect, and server 300 could correspond to an exemplary embodiment of an apparatus according to the presented second aspect.

The cellular communication network 402 could be based on any kind of cellular system, for instance a GSM system, a 3rd Generation Partnership Project (3GPP) based cellular system like a WCDMA system or a TD-SCDMA system, a 3GPP2 system like a CDMA2000 system, a LTE or LTE-Advanced system, or any other type of cellular system, like a worldwide interoperability for microwave access (WiMAX) system.

Each of the WLANs 403 comprises at least one access point. To each access point, a BSSID has been assigned by a manufacturer of the access point. In addition, an SSID may have been assigned to the access point by the operator of the WLAN.

Server 500 is one of a plurality of servers. Each of these servers is configured to process fingerprint data for another set of MCCs. The processed data may be stored in a database within server 500 or external to server 500.

Mobile terminal 600 comprises a WLAN module for performing WLAN scans and optionally for exchanging information with other devices via WLANs 403. Mobile terminal 600 further comprises a global positioning system (GPS) receiver as an exemplary GNSS receiver. Mobile terminal 600 may comprise in addition a cellular engine for exchanging information with other devices via cellular network 402.

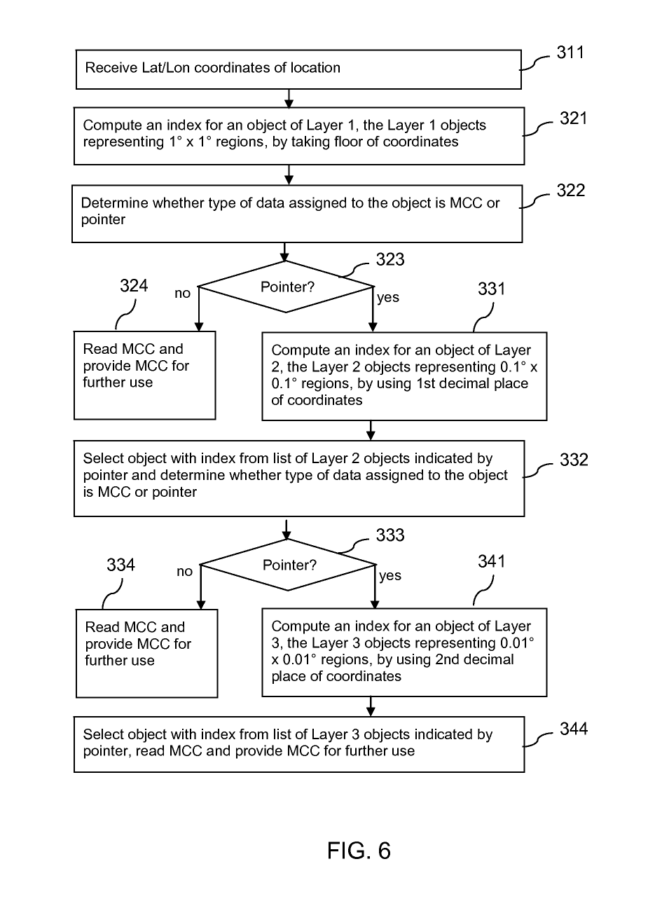

An exemplary operation in the system of FIG. 4 will now be described with reference to the flow chart of FIG. 6.

FIG. 6 presents the operations at server 300. Processor 301 and the program code stored in memory 302 cause server 300 to perform the presented operations when the program code is retrieved from memory 302 and executed by processor 301.

Mobile terminal 600 creates at regular intervals a report with fingerprint data. Each report may include coordinates of a position of mobile terminal 600. The coordinates may comprise latitude and longitude values and be based on GPS signals detected at mobile terminal 600. The report may include in addition results of a WLAN scan, that is, results of the evaluation of signals transmitted by WLAN access points and received by mobile terminal 600 at the indicated position. The results of the WLAN scan may include for all WLAN access points, from which signals can be observed at the indicated position, the BSSID as the MAC address of the access point and, optionally, the signal strength of observed WLAN signals at the indicated position and/or other information. The entire report is transmitted by mobile terminal 600 to server 300 in a message via cellular network 402 and network 401 or via a WLAN 403 and network 401. Similar reports may be provided by other mobile terminals.

Server 300 receives the message with the report including the coordinates from mobile terminal 600. (action 311)

Server 300 may be responsible for forwarding the report to another server, which is responsible for managing the fingerprint data for a particular MCC, for instance server 500. In order to be able to forward the report to the appropriate server, server 300 maps the coordinates of the position in the included fingerprint data to an MCC, using the database in memory 306.

Based on the coordinates of the position in the received fingerprint data, server 300 computes an index for an object of Layer 1. (action 321) This is achieved by taking the floor function of the latitude value and the floor function of the longitude value of the coordinates. If the objects are represented by a static 180-by-360 table as suggested above, the floor function of the latitude value may identify a particular row of the table, and the floor function of the longitude value may identify a particular column of the table. The thus identified element of the table can be considered a selected object, which comprises an indication of the data type as a first part and the data of the object as a second part.

Next, server 300 determines whether the type of the data that is assigned to the selected object is an MCC or a pointer. (action 322) The corresponding information can be taken from the type part of the selected object. For instance, a region with the lower-left coordinates of N61° E23° is located completely within Finland, so that the corresponding object of Layer 1 may comprise the data MCC=244 for Finland, instead of a pointer to Layer 2.

In case the data type is “MCC”, and thus not “pointer” (action 323), server 300 reads the MCC from the data part of the selected object. (action 324) The value is provided for further use.

In case the data type of the selected object is “pointer” (action 323), server 300 computes an index for an object of Layer 2. (action 331) This is achieved by extracting the respective first decimal place of the coordinates, using the following equation:

Index=(floor((Lat-floor(Lat))/0.1)<<4)|floor((Lon-flo or(Lon))/0.1)

The first decimal place of the latitude value and the first decimal place of the longitude value may each be represented by 4 bits, and by shifting the latitude part by 4 bits as indicated, a one byte index can be created.

Next, server 300 selects the Layer 2 object that is identified by the computed index and determines whether the type of the data that is assigned to the selected object is “MCC” or “pointer”. (action 332) The object can be selected for instance from a sorted indexed list of objects or from a table.

In case the data type is “MCC”, and thus not “pointer” (action 333), server 300 reads the MCC from the data part of the object selected in action 332. (action 334) The value is provided for further use.

In case the data type is “pointer” (action 333), server 300 computes an index for an object of Layer 3. (action 341) This is achieved by extracting the respective second decimal place of the coordinates, using the following equation:

Index=floor(((Lat/0.1)−floor(Lat/0.1))/0.1)<<4|floor(((Lon/0.1)−floor(Lon/0.1))/0.1)

Next, server 300 selects the object of Layer 3 that is identified by the computed index and reads the MCC from the data part of the selected object. (action 344) The object can be selected for instance from a sorted indexed list of objects or from a table. The value is provided for further use.

Thus, actions 311 to 344 can be an embodiment of a mapping of a location to an identifier of an area according to the first aspect.

The MCC value that is provided in action 324, 334 or 344 for further use may be used by server 300 for selecting a server that is responsible for the management of fingerprint data for the determined MCC, for instance server 500. Server 300 could then forward the received report, or selected fingerprint data from the report, to selected server 500.

At server 500, the received fingerprint data could be stored and/or used for generating refined model data for all WLAN access points for which data is included in the fingerprint data. Such model data could comprise for instance a location of the access point, estimated as the average of GPS locations that have been stored as information about the access point and that indicate from which locations reports have been received for this access point. Such model data could comprise for instance parameters defining a coverage area of the access point, estimated based on GPS locations that have been stored as information about the access point and that indicate from which locations reports have been received for this access point. Such model data could comprise for instance parameters of a radio propagation model determined based on signal strength measurements that have been stored as information about the access point. Such a radio propagation model may predict for each location the expected signal strength of signals transmitted by the WLAN access point. The received fingerprint data for an access point and/or data for a refined model for an access point may be stored in a database in a memory of server 500 or in a memory of another device.

In alternative embodiments, the MCC value that is provided in action 324, 334 or 344 may be used for other purposes.

For example, server 300 could take care itself of storing and/or processing the received fingerprint data. In this case, server 300 could use the determined MCC for storing the data in different internal or external databases that are associated to different MCCs.

Further alternatively, server 300 could use the determined MCC for storing received and/or processed data for a WLAN access point such that it is assigned to a BSSID of an access point as a primary key and to the determined MCC as a secondary key.

It is to be understood that all or a part of actions 311 to 344 could also be realized at mobile terminal 600, for instance if mobile terminal 600 takes care of selecting one of a plurality of servers, to which collected fingerprint data is to be sent, based on the provided MCC.

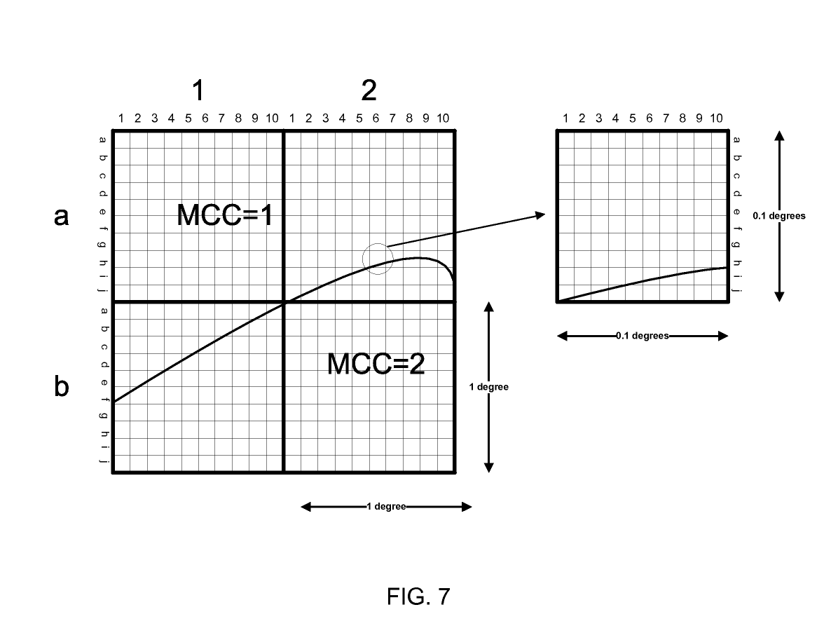

FIG. 7 is a diagram illustrating the generation of the entries of the database in memory 306 of server 300 of FIG. 4, for instance of the MCCs of the objects of FIG. 5.

FIG. 7 shows on the left hand side four exemplary regions “1a”, “2a”, “1b” and “2b”. Each region is represented by a Layer 1 object. An upper part of the regions belongs to a first country with assigned identifier MCC=1, and a lower part of the regions belongs to a second country with assigned identifier MCC=2. The frontier between the countries is shown by a curved line. It is to be understood that the notation “MCC=1” and “MCC=2” is used to represent any of the three digit mobile country codes that are assigned to a pair of neighboring countries.

Region “ 1a” belongs completely to the country with assigned identifier MCC=1, and region “2b” belongs completely to the country with assigned identifier MCC=2. The objects of Layer 1 representing these regions may therefore carry the MCC information as data; Layer 2 objects are not needed for these Layer 1 objects.

Each of regions “1b” and “2a”, however, belongs partly to the country with assigned identifier MCC=1 and partly to the country with assigned identifier MCC=2. Therefore, regions “1b” and “2a” are divided into a plurality of Layer 2 regions, for instance 10×10=100 regions “1a” to “10j”, each having a size of 0.1×0.1 degrees. Each of these Layer 2 regions is represented by a Layer 2 object. In the Layer 1 object representing region “1b”, there is a pointer to a corresponding object table—or indexed sorted list—for Layer 2, and in the Layer 1 object for region “2a”, there is equally a pointer to a corresponding object table—or indexed sorted list—for Layer 2.

Most of the Layer 2 regions within Layer 1 regions “1b” and “2a” belong completely to the country with assigned identifier MCC=1 or the country with assigned identifier MCC=2. The Layer 2 objects representing these Layer 2 regions thus comprise data including the respective MCC. Layer 3 objects are not needed for these Layer 2 objects. In the example on the left hand side of FIG. 7, it can be seen for instance that the Layer 2 region “2a::1i” lies completely within the country with assigned identifier MCC=1, and thus no Layer 3 objects need to be stored under the Layer 2 object “2a::1i”. In the notation “Xx::Yy”, Xx represents a Layer 1 object, and Yy represents a Layer 2 object.

Some of the Layer 2 regions within Layer 1 regions “1b” and “2a”, however, belong partly to the country with assigned identifier MCC=1 and the country with assigned identifier MCC=2.

On the left hand side of FIG. 7, one of these Layer 2 regions “2a::6h” is circled. This Layer 2 is drawn to a larger scale on the right hand side of FIG. 7.

Here, the Layer 2 region is divided into a plurality of Layer 3 regions, for instance 10×10=100 regions “2a::6h:: 1a” to “2a::6h::10j”, each having a size of 0.01×0.01 degrees. Layer 3 objects are defined for each of these Layer 3 regions. In the notation “Xx:Yy:Zz”, Xx represents a Layer 1 object, Yy represents Layer 2 object, and Zz represents a Layer 3 object. The frontier between the countries is shown again by a curved line.

Most of the Layer 3 regions within the presented Layer 2 region belong completely to the country with assigned identifier MCC=1 or to the country with assigned identifier MCC=2. The corresponding Layer 3 objects thus comprise data including the respective MCC. However, some of the Layer 3 regions belong partly to the country with assigned identifier MCC=1 and partly to the country with assigned identifier MCC=2. In this case, the MCC is selected, which identifies the country to which the largest part of the Layer 3 region belongs. The selected MCC is then used as data in the corresponding Layer 3 object.

Under the Layer 2 object representing the Layer 2 region “2a::6h” on the right hand side of FIG. 7, the objects of the Layer 3 regions would thus carry for example the following MCC information:
2a::6h::1a to 2a::6h::10a−>MCC=1
2a::6h::1b to 2a::6h::10b−>MCC=1
2a::6h::1c to 2a::6h::10c−>MCC=1
2a::6h::1d to 2a::6h::10d−>MCC=1
2a::6h::1e to 2a::6h::10e−>MCC=1
2a::6h::1f to 2a::6h::10f−>MCC=1
2a::6h::1g to 2a::6h::10g−>MCC=1
2a::6h::1h to 2a::6h::10h−>MCC=1
2a::6h::1i to 2a::6h::6i−>MCC=1
2a::6h::7i to 2a::6h::10i−>MCC=2
2a::6h::1j to 2a::6h::2j−>MCC=1
2a::6h::3j to 2a::6h::10j−>MCC=2

As mentioned above, multiple MCCs have been assigned in ITU E.212 to some countries. This may be taken into account in different ways when creating a database for the presented first or second aspect. It could be decided, for instance, that a single MCC per country is used in the database. For example for India, only MCC ‘404’ could be used in the database, even though MCCs ‘404’, ‘405’ and ‘406’ are assigned to India in ITU E.212. Alternatively, the structure of the presented database could be slightly modified to enable a storage of multiple MCCs as data of a single object. In order to avoid a general increase of storage space to this end, it would also be possible to include in the data part of an object a pointer that points to a list of MCCs assigned to a particular country, in case the data type part of the object indicates that the data part of the object includes such a pointer. In this case, it might be necessary to include a data type part in the Layer 3 objects as well. In actions 324, 334 and 344 of FIG. 6 it would then be possible to provide a plurality of MCCs for further use.

Occasionally, fingerprint data may be collected at a location that does not belong to any country. A mobile terminal might detect for instance a WLAN onboard a freight ship crossing the Atlantic when performing a WLAN scan. Such a WLAN could be detected as being mobile and blacklisted for positioning purposes. Nevertheless, such a situation could be considered in addition in the scope of a location-to-MCC mapping. The locations that do not lie within a country, to which an MCC has been assigned, could be mapped to some special MCC value. Alternatively, in order to save memory, it could be defined that in case there is no MCC information present in a Layer 3 object, or in a Layer 1 or Layer 2 object with data type “MCC”, then this corresponds to some special MCC value. In a typical scenario, available fingerprint data could be discarded, in case such a special value is returned by a Location-to-MCC mapping, because it is originating from an invalid area.

Summarized, certain embodiments of the invention may have the effect of facilitating a mapping of coordinates of a location to an identifier of an area. In crowd-sourcing scenarios, as an exemplary use case of the invention, the inflow of data into the system is typically extremely high, for example in the order of 100 million fingerprints per day. This corresponds to up to 1000 fingerprints per seconds. In case location-to-area mapping is needed, the mapping thus needs to be particularly fast. The required performance can be achieved with a memory-resident mapping table that utilizes a geospatial tree structure for quick access, as presented with reference to exemplary embodiments of the first and second aspect.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:
(a) hardware-only circuit implementations (such as implementations in only analog and/or digital circuitry)
(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101 or 301 in combination with memory 102 or 302, respectively, or the integrated circuit 305 can also be viewed as means for receiving coordinates of a location; means for selecting an object of a first layer of a tree structure based on the received coordinates; means for determining whether data assigned to a selected object comprises an identifier of an area or a pointer to a set of objects of a respective next layer of the tree structure, wherein each object represents a region and wherein a region represented by an object of any layer but the first layer is a sub-region of a region represented by an object of the preceding layer; means for selecting one of the objects from the set of objects based on the received coordinates, if the data comprises a pointer to a set of objects; and means for reading the data comprising the identifier, if the data comprises an identifier of an area, and for providing the identifier as a result of a mapping of a location to an identifier of an area.

The program codes in memory 102 and 302, respectively, can also be viewed as comprising such means in the form of functional modules.

FIGS. 2 and 6 may also be understood to represent exemplary functional blocks of computer program codes supporting a mapping of a location to an identifier of an area.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-24. (canceled)

25. A method comprising:
a) receiving, by an apparatus, coordinates of a location;
b) selecting, by the apparatus, an object of a first layer of a tree structure based on the received coordinates;
c) determining, by the apparatus, whether data assigned to the selected object comprises an identifier of an area or a pointer to a set of objects of a respective next layer of the tree structure, wherein each object represents a region and wherein a region represented by an object of any layer but the first layer is a sub-region of a region represented by an object of the preceding layer;
d) if the data comprises a pointer to a set of objects, selecting, by the apparatus, one of the objects from the set of objects based on the received coordinates and continuing with action c); and
e) otherwise, if the data comprises an identifier of an area, reading, by the apparatus, the data comprising the identifier and providing the identifier as a result of a mapping of a location to an identifier of an area.

26. The method according to claim 25, wherein the identifier of the area is a mobile country code.

27. The method according to claim 25, wherein the tree structure comprises three layers and wherein
each object of the first layer represents a region of one degree in longitude direction and one degree in latitude direction;
each object of the second layer represents a region of 0.1 degree in longitude direction and 0.1 degree in latitude direction; and
each object of the third layer represents a region of 0.01 degree in longitude direction and 0.01 degree in latitude direction.

28. The method according to claim 25, wherein an object is selected based on the received coordinates by computing an index for the object based on the received coordinates, and wherein
an index of an object of a first layer is computed as a combination of an integer part of a latitude coordinate value in degrees of the received coordinates and of an integer part of a longitude coordinate value in degrees of the received coordinates;
an index of an object of a second layer is computed as a combination of a first place after a decimal point of a latitude coordinate value in degrees of the received coordinates and of a first place after a decimal point of a longitude coordinate value in degrees of the received coordinates; and
an index of an object of a third layer is computed as a combination of a second place after a decimal point of a latitude coordinate value in degrees of the received coordinates and of a second place after a decimal point of a longitude coordinate value in degrees of the received coordinates.

29. The method according to claim 25, wherein an object comprises an identifier of an area either
in case the object is an object of a lowest layer of the tree structure; or
in case the object represents a region that belongs entirely to the area.

30. The method according to claim 25, wherein an object of a lowest layer of the tree structure comprises an identifier of an area which is selected such that
the region represented by the object belongs in its entirety to the area; or
the largest part of the region represented by the object belongs to the area.

31. An apparatus comprising at least one processor and at least one memory including computer program code, the at least one memory and the computer program code configured to, with the at least one processor, cause an apparatus at least to perform:
a) receive coordinates of a location;
b) select an object of a first layer of a tree structure based on the received coordinates;
c) determine whether data assigned to the selected object comprises an identifier of an area or a pointer to a set of objects of a respective next layer of the tree structure, wherein each object represents a region and wherein a region represented by an object of any layer but the first layer is a sub-region of a region represented by an object of the preceding layer;
d) if the data comprises a pointer to a set of objects, select one of the objects from the set of objects based on the received coordinates and continue with action c); and
e) otherwise, if the data comprises an identifier of an area, read the data comprising the identifier and provide the identifier as a result of a mapping of a location to an identifier of an area.

32. The apparatus according to claim 31, wherein the identifier of the area is a mobile country code.

33. The apparatus according to claim 31, wherein the tree structure comprises three layers and wherein
each object of the first layer represents a region of one degree in longitude direction and one degree in latitude direction;
each object of the second layer represents a region of 0.1 degree in longitude direction and 0.1 degree in latitude direction; and
each object of the third layer represents a region of 0.01 degree in longitude direction and 0.01 degree in latitude direction.

34. The apparatus according to claim 31, wherein the computer program code is configured to, with the at least one processor, cause the apparatus to select an object based on the received coordinates by computing an index for the object based on the received coordinates, and to
compute an index of an object of a first layer as a combination of an integer part of a latitude coordinate value in degrees of the received coordinates and of an integer part of a longitude coordinate value in degrees of the received coordinates;
compute an index of an object of a second layer as a combination of a first place after a decimal point of a latitude coordinate value in degrees of the received coordinates and of a first place after a decimal point of a longitude coordinate value in degrees of the received coordinates; and
compute an index of an object of a third layer as a combination of a second place after a decimal point of a latitude coordinate value in degrees of the received coordinates and of a second place after a decimal point of a longitude coordinate value in degrees of the received coordinates.

35. The apparatus according to claim 31, wherein an object comprises an identifier of an area either
in case the object is an object of a lowest layer of the tree structure; or
in case the object represents a region that belongs entirely to the area.

36. The apparatus according to claim 31, wherein the computer program code is configured to, with the at least one processor, cause the apparatus to select an identifier of an area comprised by an object of a lowest layer of the tree structure such that
the region represented by the object belongs in its entirety to the area; or
the largest part of the region represented by the object belongs to the area.

37. The apparatus according to claim 31, wherein the apparatus is one of:
a server;
a component for a server;
a mobile device; and
a component for a mobile device.

38. A non-transitory computer readable storage medium in which a database is stored, the database being configured to have a tree structure which enables storage of:
objects arranged in at least two layers, wherein each object represents a region and wherein a region represented by an object of any layer but the first is a sub-region of a region represented by an object of the preceding layers,
with objects of at least one of the layers being at least configured to comprise a pointer to a set of objects of a next layer, and with objects of at least one of the layers being at least configured to comprise a respective identifier of an area.

39. The non-transitory computer readable storage medium according to claim 38, wherein the identifier of an area is a mobile country code.

40. The non-transitory computer readable storage medium according to claim 38, wherein the tree structure comprises three layers and wherein
each object of the first layer represents a region of one degree in longitude direction and one degree in latitude direction;
each object of the second layer represents a region of 0.1 degree in longitude direction and 0.1 degree in latitude direction; and
each object of the third layer represents a region of 0.01 degree in longitude direction and 0.01 degree in latitude direction.

41. The non-transitory computer readable storage medium according to claim 38, wherein an object comprises an identifier of an area either
in case the object is an object of a lowest layer of the tree structure; or
in case the object represents a region that belongs entirely to the area.

42. The non-transitory computer readable storage medium according to claim 38, wherein an object of a lowest layer of the tree structure comprises an identifier of an area which is selected such that
the region represented by the object belongs in its entirety to the area; or
the largest part of the region represented by the object belongs to the area.
